(19) United States
(12) Patent Application Publication
(10) Pub. No.: US 2005/0083900 A1
(43) Pub. Date: Apr. 21, 2005

(54) Event based reporting method

(75) Inventors: J. Gonzalo Wanguemert Perez, Malaga (ES); Antti Tolli, Oulu (FI); Petteri Hakalin, Oulu (FI); Juan Antonio Gomez Salvador, Malaga (ES)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/970,277

(22) Filed: Oct. 22, 2004

Related U.S. Application Data
(63) Continuation of application No. PCT/FI03/00363, filed on May 12, 2003.

(30) Foreign Application Priority Data
May 15, 2002 (FI) 20020916

(51) Int. Cl. H04B 7/216

(52) U.S. Cl. 370/342

(57) ABSTRACT

The present invention optimises and reduces the needed information exchange between network entities through the interfaces which connect them. The main property of the event based reporting method of the present invention is its flexibility because it is able to change the reporting rate depending on the value of the input parameter in each instant of time. That is, it sends more reports or less reports depending on if the parameter to be reported is changing quickly or slowly, respectively. The main idea of the present invention is that reports of a data network parameter are based on the relative change of the data network parameter value with respect to the previously reported data network parameter value.

### FIELD OF THE INVENTION

The present invention relates to mobile telecommunication systems. In particular, the present invention relates to a novel and improved method and system for reporting network parameters.

### BACKGROUND OF THE INVENTION

Different elements or entities of a network are continuously interchanging information between them. The way in which such exchange is performed will affect to the signalling reporting rate and could saturate the capacity of the interfaces.

For example, in coming multisystem or multilayer networks it is essential to utilise all the systems or layers in the most efficient way. For this reason, a new network element, the Common Radio Resource Management (CRRM), is being developed. The main functionality of the CRRM is to be able to direct the connections in the call set-ups and handovers to the optimum cell within optimum radio access technology (RAT) depending on the Quality of Service (QoS) requirements of the connection. The algorithms of the CRRM for the target cell selection and auto-tuning are based on the input parameters read from the respective interfaces. These parameters represent the status information of the different cells. Parameters can, for example, be the total load, RTLoad (RT, Real Time), SIR (Signal to Interference Ratio) and NRT Delay (NRT, Non Real-Time). Another example in which common measurements have to be reported is the Iur-interface between different Radio Network Controllers (RNC). This is actually one alternative for CRRM and requires event triggered reports.

The ETSI (European Telecommunication Standardisation Institute) TS 125 423 V4.1.0 (2001-06) describes several different methods how the cell measurements can be sent. The scope of the TS 125 423 V4.1.0 (2001-06) document is to specify the radio network layer signalling procedures of the control plane between Radio Network Controllers (RNC) in Universal Terrestrial Radio Access Network (UTRAN). One of the aspects considered at the standard is how the reporting of a dedicated measurement shall be performed between a Serving RNC (SRNC) and a Drift-RNC (DRNC). The different measurement reporting methods proposed at the standard can be grouped in two categories: the measured entity value no-dependent methods and the dependent ones. The first category includes the ‘on-demand’ and ‘periodic’ strategies, which are defined at the standard as:
If the Report Characteristics IE is set to ‘on-demand’, the DRNC shall report the measurement result immediately.
If the Report Characteristics IE is set to ‘periodic’, the DRNC shall periodically initiate the Dedicated Measurement Report procedure for this measurement, with the requested report periodicity.

On the other hand, the methods belonging to the second category, the measured entity value dependent ones, are labelled as ‘Event A’, ‘Event B’, . . . , until ‘Event F’. Among them, the ‘Event C’ and the ‘Event D’ strategies are described in more detail in the following.

If the Report Characteristics IE is set to ‘Event C’, the DRNC shall initiate the Dedicated Measurement Reporting procedure when the measured entity rises by an amount greater than the requested threshold (Mc) within the requested time (Tc). After having reported this type of event, the next C event reporting for the same measurement cannot be initiated before the rising time has elapsed since the previous event reporting.
If the Report Characteristics IE is set to ‘Event D’, the DRNC shall initiate the Dedicated Measurement Reporting procedure when the measured entity falls by an amount greater than the requested threshold (Md) within the requested time (Td). After having reported this type of event, the next D event reporting for the same measurement cannot be initiated before the falling time has elapsed since the previous event reporting.

The periodic strategy is typically the chosen one because of its simplicity. It is obvious that a low period would assure a good decision or subsequent action, but at the same time could saturate the processing capacity of the entity which receives the reports, like for example in a star configuration with a large number of entities connected to a unique one. On the other hand, a high period would reduce the number of messages to be processed by the receiving entity but the decision would be less reliable.

In one possible solution, event C, event D and periodic strategies can be combined. FIG. 1 illustrates a situation where event C and event D strategies are combined. If the entity to be reported is changing very slowly, no reports will be sent by using the event C and event D simultaneously, as it can be seen from FIG. 1. In the situation showed in the figure it is observed that the slope of the entity between tₒ-t₁ is always less than that defined by the parameters (Mc,Tc) with which the performance of the event C is specified.

To overcome such drawback, two alternatives can be used:
a) Increasing the time Tc as it is shown in FIG. 2. This way a measurement report will be taken at the instant t_{MR}. This strategy has the problem that no reports are generated during the time ‘Tc new’, and sometimes this time interval can be very large and prohibitive e.g. for the CRRM application. Besides, the required ‘Tc new’ is not known in advance. A difficult situation would be, for example, during the night in which many parameters of the network can be zero for several hours. However, an excessive increment could cause dramatic consequences in the performance of both reporting methods. The problem is in that, as it says the standard, “. . . the next C and D event reporting for the same measurement cannot be initiated before the rising/falling time has elapsed since the previous event reporting”. Therefore, the more Tc is enlarged, the more is e.g. the time that the Serving RNC must be without any notice about the status of the measured entity. Moreover, it can happen that significant changes are taking place during this time.
b) It is evident that the aforementioned solution is very inefficient in situations in which the measured entity changes very slowly but, at the same time, it is necessary to maintain e.g. a SRNC well informed, at least with certain frequency. Therefore, a unique possible solution supported by the standard would be the utilisation of a periodic report as it is shown in FIG. 3. This way, although no reports are generated by fast changes (increasing or decreasing) in the measured entity, a minimum number of them would be assured. The period, or distance between reports, should be chosen according to the following condition:
   Tc,Td<Period<Maximum time without reports
That is to say, it must be greater than Tc and Td, and less than the allowed maximum time without reports.

However, the simultaneous use of the periodic strategy in conjunction with the ‘Event C’ and ‘Event D’ strategies will produce a inefficient reporting rate. The reason is that they are uncoupled, that is, a periodic report will always be produced each period of time, without taking into account if reports by fast changes in the value of the measured entity have recently been sent (caused by event C or D). Therefore, it is sure that an unnecessary number of periodic reports will be sent, especially if the selected period is low.

Although any of the measurement reporting strategies suggested in the standards can also be used to exchange information between entities, none of them is so efficient as the proposed one in the present invention. The reason is that they are based on the absolute value of the input parameter or how fast the parameter to be reported is varying, that is, in the observed slope.

### SUMMARY OF THE INVENTION

The present invention describes a flexible reporting method, system and data network entity for interchanging information between different entities of a data network. The data network comprises one or more data network parameters to be reported between different entities.

The present invention optimises and reduces the needed information exchange between network entities through the interfaces which connect them. The main property of the method of the present invention is its flexibility because it is able to change the reporting rate depending on the value of the input parameter in each instant of time. That is, it sends more reports or less reports depending on if the parameter to be reported is changing quickly or slowly, respectively. The main idea of the present invention is that reports of a data network parameter are based on the relative change of the data network parameter value with respect to the previously reported data network parameter value.

In a preferred embodiment of the present invention, three different control parameters are used to specify the performance of the method:
Threshold
MinTBR: Minimum Time Between Reports
MaxTBR: Maximum Time Between Reports.

The ‘Threshold’ allows us to fix the desired sensibility of the method. If a low value is selected, the algorithm will inform us about light changes in the input data but the reporting rate will be higher. On the other hand, if a large value is allowed, only significant changes will be noticed, although in this case the number of needed measurement reports will be lower.

The ‘MinTBR’ represents the time interval after the last reported value in which no reports are allowed. That is, if an increase/decrease of the input data over/under the fixed threshold occurs between ‘0’ and ‘MinTBR’ seconds after the last reported value, the report is not sent.

The ‘MaxTBR’ represents the maximum time that the entity to be informed can be without knowing the current status of the parameter to be reported. That is, if no report is initiated between ‘MinTBR’ and ‘MaxTBR’, a mandatory one will be sent at MaxTBR. This control parameter does two tasks: not only it guarantees a minimum reporting rate between entities but also serves to check that everything is going well. For example, if no reports are received neither between ‘MinTBR’ and ‘MaxTBR’ nor after ‘MaxTBR’, it is sure that a technical problem has occurred (e.g. the connection may have been lost). Notice also that when the parameter ‘MinTBR’ is equal to ‘MaxTBR’, the event based reporting method works like a periodic reporting rate (no random reports are allowed).

In one embodiment of the present invention data network parameter values are filtered before reporting them. The filtering is done e.g. an Infinite Impulse Response (IIR) of Finite Impulse Response (FIR) filter.

In one embodiment of the present invention the data network is a wireless communication network. The reported wireless network parameter values are reported, e.g. with a radio resource controller of the wireless communication network. Correspondingly, the reported wireless network parameter values are received, e.g. with a radio resource management node of the wireless communication network.

In one embodiment of the present invention, the wireless communication network is the UTRAN, the IP-RAN, the GSM, the GPRS or the EDGE.

The present invention has several advantages over the prior-art solutions. With the new strategy the reporting rate is continuously and automatically optimised according to the current value of the parameter to be reported.

The key of the adaptive method described in the present invention to implement the event based reporting method is that it has a memory. The decision to trigger a measurement report is based on which is the difference, in each instant of time, between the value of the parameter to be reported and the last reported value. In doing so, the following advantages are obtained:
Optimum performance: the receiving entity is well informed about what is the status of the network without an excessive increment of the reporting rate.
Automatic adjust of the required reporting rate between entities. With the new strategy the reporting rate between entities is continuously and automatically optimised according to the current value of the parameter to be reported. That is, more or less reports are sent depending on if the measurement to be reported is changing quickly or slowly, respectively.
Flexibility: the parameters ‘MinTBR’, ‘MaxTBR’ and ‘Threshold’ can be changed to adapt the performance of the method to the specific characteristics of a real network.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an example where event C and event D strategies are used in accordance with the ETSI TS 125 423 V4.1.0 (2001-06),

FIG. 2 illustrates an example where event C and event D strategies are used where time T1 value is increased, in accordance with the ETSI TS 125 423 V4.1.0 (2001-06),

FIG. 3 illustrates an example where event C, event D and periodic strategies are simultaneously used in accordance with the ETSI TS 125 423 V4.1.0 (2001-06),

FIG. 4 is a block diagram illustrating of the event based reporting method in accordance with the present invention,

FIG. 5 illustrates the principle of the event based reporting method in accordance with the present invention,

FIG. 6 is an embodiment of the system in accordance with the present invention,

FIG. 7 is an embodiment of the system in accordance with the present invention,

FIG. 8a illustrates the evolution of the mean rate of call generation used in the simulations,

FIG. 8b illustrates the load of a cell during a day within the simulations,

FIG. 9 illustrates an example of simulation results of event C, event D and periodic strategies versus the event based method in accordance with the present invention,

FIG. 10 illustrates an example of simulation results of the event C, event D and periodic strategies versus the event based method in accordance with the present invention,

FIG. 11 illustrates an example of simulation results of the event C, event D and periodic strategies versus the event based method in accordance with the present invention,

FIG. 12 illustrates an example of simulation results of the event C, event D and periodic strategies versus the event based method in accordance with the present invention,

FIG. 13 illustrates an example of simulation results of the event based method in accordance with the present invention, and

FIG. 14 illustrates an example of simulation results of the event based method in accordance with the present invention.

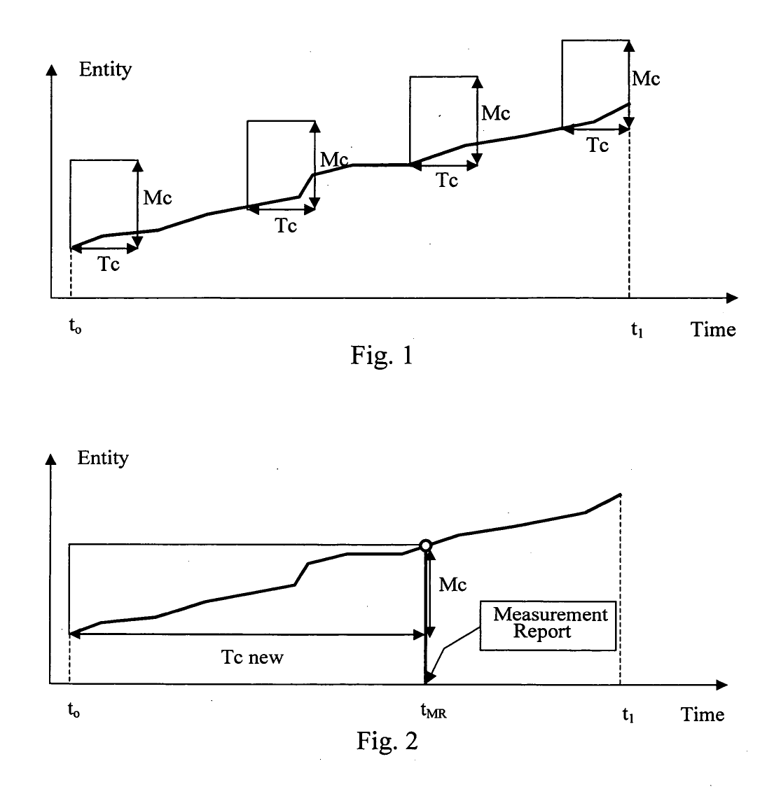

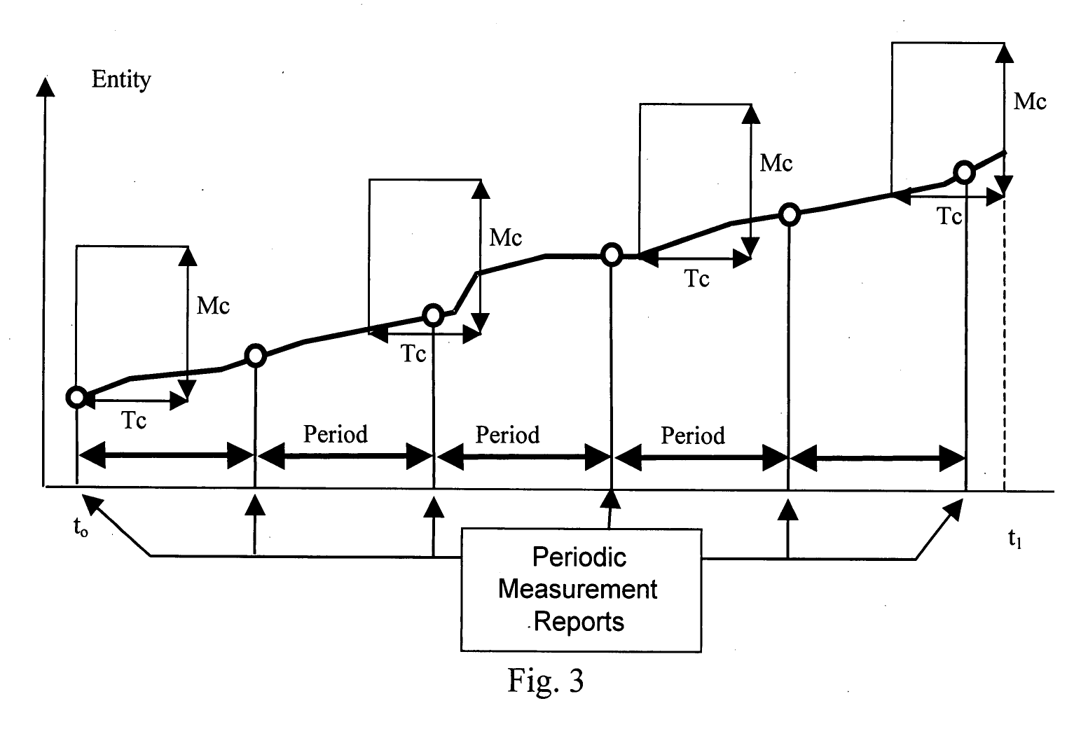

### DETAILED DESCRIPTION OF THE INVENTION

Reference will now be made in detail to the embodiments of the present invention, examples of which are illustrated in the accompanying drawings.

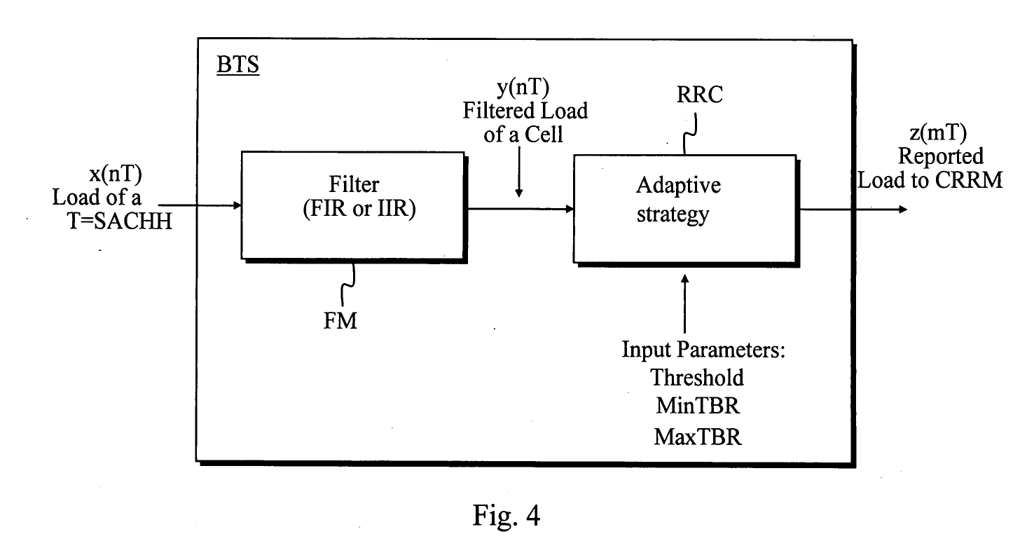

FIG. 4 is a block diagram illustrating of the event based reporting method. FIG. 4 comprises a Base Station (BTS) and one or more entities to be reported. In this example, the entity to be reported is the Real Time load (RTload). Samples of the entity are input to the BTS e.g. one sample per each SACHH frame. In order to smooth the profile of the input data a low pass filter (FIR of IIR) can be used before the reporting process. Taking the load as input data, an adaptive strategy (event based reporting method) is then applied to produce the load reports sequence to be sent to radio resource management, e.g. to the Common Radio Resource Management (CRRM). Although FIG. 4 represents a filter feature FM previous to the adaptive strategy RRC, filtering is not obligatory. The adaptive strategy mentioned means the same as the event based reporting method in the description.

The adaptive strategy RRC receives in FIG. 4 three input parameters:
MaxTBR: Maximum Time Between Reports
MinTBR: Minimum Time Between Reports
Threshold.

When the event based reporting method is applied to the filtered load using the input parameters as rules, the reported values can be sent to the CRRM.

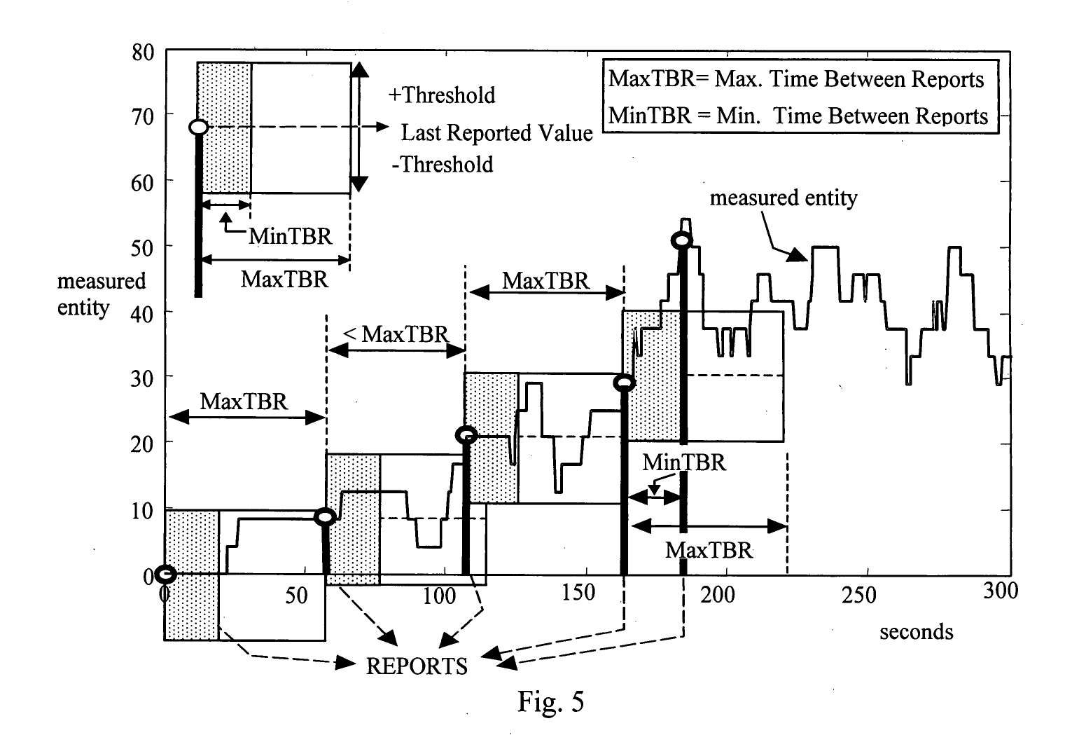

FIG. 5 illustrates the principle of the event based reporting method. The three parameters (MinTBR, MaxTBR, Threshold) are first explained in more detail.

The ‘Threshold’ allows us to fix which is the desired sensibility of the event based reporting method. If a low value is selected, the algorithm will inform us about light changes in the input data, but the reporting rate will be higher. On the other hand, if a large value is allowed, only significant changes will be noticed, although in this case the number of needed measurement reports will be lower.

The ‘MinTBR’ represents the time interval after the last reported value in which no reports are allowed. That is, if an increase/decrease of the input data over/under the fixed threshold occurs between ‘0’ and ‘MinTBR’ seconds after the last reported value, the report is not sent. This delay parameter has been defined in order to introduce a degree of freedom to control an excessive number of measurement reports between the network entities.

The ‘MaxTBR’ represents the maximum time that the entity to be informed can be without knowing the current status of the parameter to be reported. That is, if no report is initiated between ‘MinTBR’ and ‘MaxTBR’, a mandatory one will be sent at ‘MaxTBR’. This control parameter does two tasks: not only it guarantees a minimum reporting rate between entities, but also serves to check that everything is going well. For example, if no reports are received neither between ‘MinTBR’ and ‘MaxTBR’ nor after ‘MaxTBR’, it is sure that a technical problem has occurred (e.g. the connection may have been lost). Notice also that when the parameter ‘MinTBR’ is equal to ‘MaxTBR’, the event based reporting method works like a periodic reporting rate (no random reports are allowed).

FIG. 5 illustrates an exemplary situation in order to describe the present invention. The x-axis describes elapsed time and the y-axis measured entity during this time. The ‘Threshold’ value compares a current input data value to the previously reported value. In FIG. 5, there are five reports sent. When a report is sent, a timer is set. The first report is always sent to initialise the process. The second report is sent after the timer reaches the ‘MaxTBR’ value since the measured entity was always included between the allowed upper and lower limits (±Threshold) during the whole time interval MinTBR<t<MaxTBR. However, the third report is sent because the threshold is reached after ‘MinTBR’ has elapsed but before ‘MaxTBR’. The fourth report is again sent at ‘MaxTBR’. Finally, the fifth report is sent at ‘MinTBR’ because, although during the interval 0<t<MinTBR the measured entity reached a value greater than the threshold, no report is allowed until ‘MinTBR’ has elapsed.

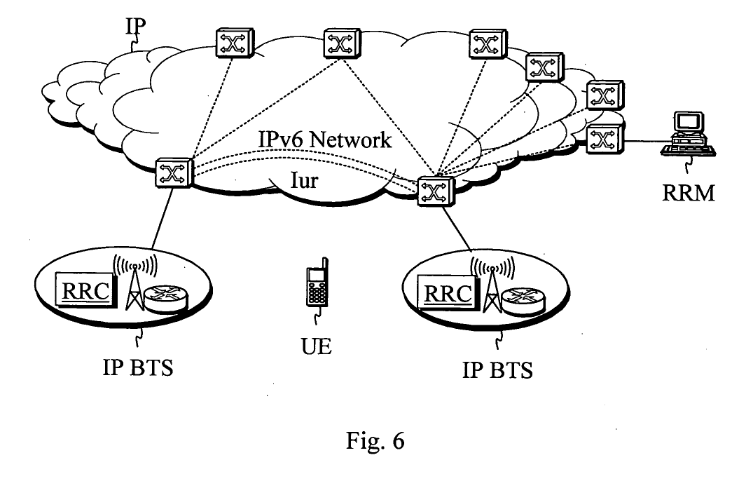

FIG. 6 represents a simplified system in accordance with the present invention. FIG. 6 represents a general IP-RAN architecture and network elements that are essential in the present invention. The system comprises IPv6 network IP and two base stations IP-BTS. User equipment UE is in connection with either or both of the base stations IP-BTS. The IPv6 network comprises one or more routers that are interconnected with each other via an interface Iur. Radio Resource Management (RRM) is connected to one of the routers. Base stations IP-BTS comprise also a Radio Resource Controller (RRC) for reporting one or more network parameter values to the RRM. It must be noted that real networks comprise also other network elements, and therefore it is clear that the system may comprise other elements too.

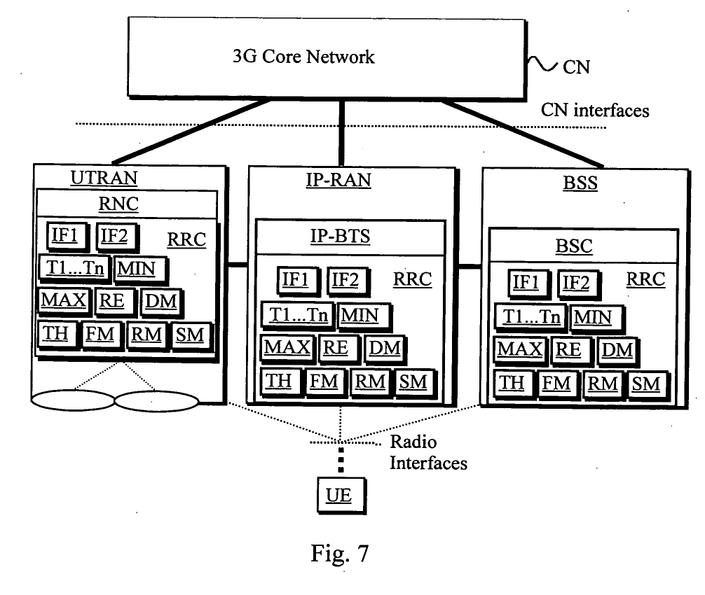

FIG. 7 is a block diagram illustrating a system in accordance with the present invention. The system comprises a core network CN, three radio access networks (UTRAN, IP-RAN, BSS) and user equipment UE. The UTRAN comprises a Radio Network Controller (RNC) which is responsible for managing radio resources. Equivalent components of the IP-RAN and BSS are Internet Protocol Transceiver Station (IP-BTS) and Base Station Controller (BSC). The RNC, IP-BTS and BSS comprise a first interface IF1 for receiving data network parameter information and a second interface IF2 for reporting one or more data network parameter values according to a reporting scheme. The reporting scheme is based on the relative change of a data network parameter value with respect to the previously reported data network parameter value. The RNC, IP-BTS and BSS comprise also means for determining DM a threshold value TH for each data network parameter to be reported, the threshold value TH representing allowable deviation in a data network parameter value to be reported with respect to the previously reported data network parameter value, means for determining DM a minimum time interval MIN representing the time interval after the previous data network parameter report within which no reports are allowed to be sent and means for determining DM a maximum time interval MAX representing the time interval after the previous data network parameter report after which a report is sent if any report has not been sent within the maximum time interval MAX.

Further, the RNC, IP-BTS and BSS comprise a timer T1 . . . Tn for each data network parameter to be reported, the timer T1 . . . Tn being started after the previous data parameter report, means for rejecting RM the report if a data network parameter to be reported changes more than the threshold value TH, and the timer T1 . . . Tn value is less than the minimum time interval MIN, means for reporting SM the current data network parameter value when a data network parameter to be reported changes more than the threshold value TH, and the value of the timer T1 . . . Tn exceeds the minimum time interval MIN and the value of the timer T1 . . . Tn is less than the maximum time interval MAX and means for restarting RE the timer T1 . . . Tn.

The RNC, IP-BTS and BSS comprise also means for reporting SM the current data network parameter value when no report has been sent after the previous data network parameter report and when the timer T1 . . . Tn reaches the maximum time interval MAX and means for filtering FM data network parameter values received with the first interface IF1 before reporting data network parameter values through the second interface IF2.

The aforementioned means are in a preferred embodiment arranged in a radio resource controller RRC. Furthermore, the aforementioned means are implemented in a preferred embodiment with software and/or hardware components.

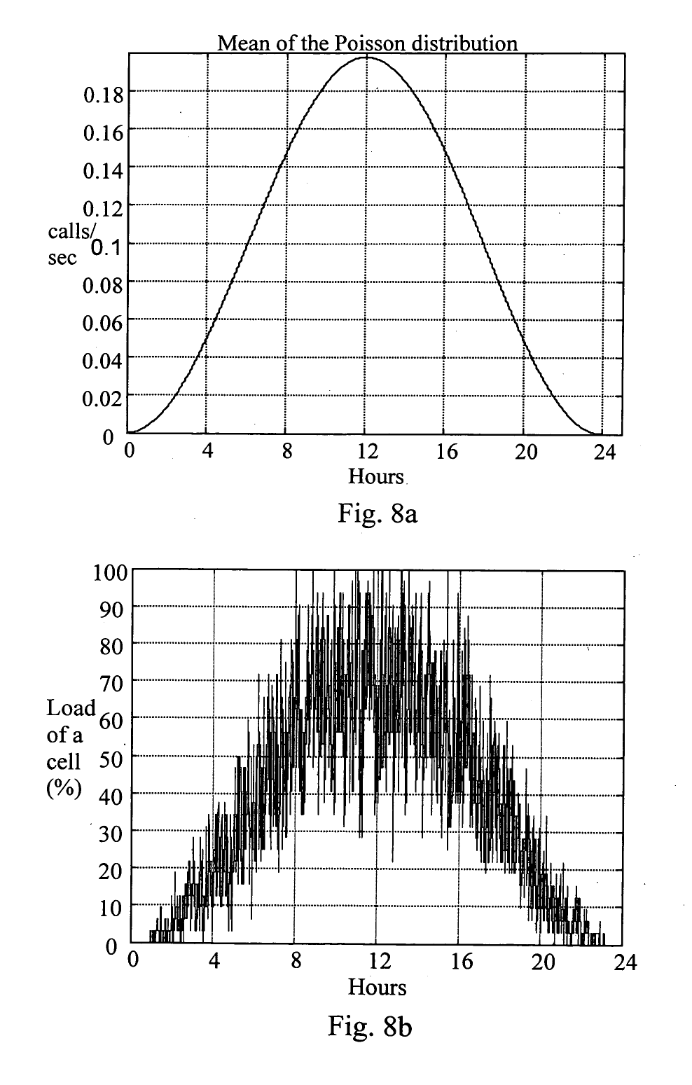

FIGS. 8a and 8b illustrate simulation scenarios during the simulations. FIG. 8a illustrates the evolution of the mean rate of call generation used in the simulations. FIG. 8b illustrates the load of a cell during a day. To make evident the weaknesses of the schemes proposed by the standard and to demonstrate the most efficient performance of the event based reporting method, a realistic situation has been simulated. Instead of using a Poisson process whose mean was maintained constant during all the simulation time, as it is done by the majority of simulators, a variable one was used at the call generation process. Specifically, a 24 hours-periodic sinusoidal function was employed at the simulations, as illustrated in FIG. 8a. The value at busy hour (at 12 h, λ=0.1972 calls/second) was selected to have a 2% blocking probability in a cell with 32 available time slots. The call length follows an exponential distribution, although, in this case, its mean was the same during the whole simulation time, specifically 120 seconds. A summary of the cell parameters used is shown in the following table.

| | | | λ | λ | | |
|---|---|---|---|---|---|---|
| | | | (call/ | (call/ | | Mean |
| Block- | | | hour) | h/user) | | call |
| ing | Time | Traffic | busy | busy | | length |
| (%) | Slots | Erlangs | hour | hour | Terminals | (sec.) |
| 2 | 32 | 23.7 | 710 | 5 | 142 | 120 |

Under the aforementioned conditions, the evolution of the instantaneous cell load during a day (sampled at each second) that was obtained is plotted in FIG. 8b. This was just the random function used as input entity to the algorithms in charge of implementing the respective reporting methods.

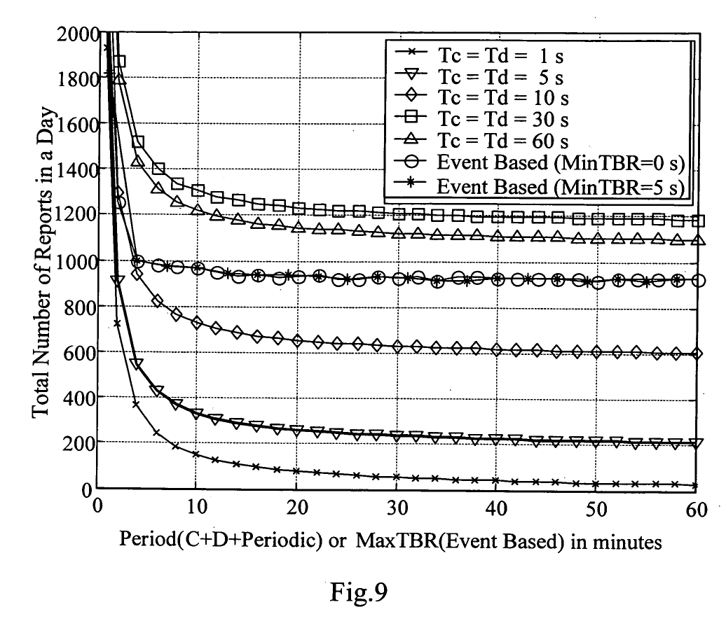

FIGS. 9-12 illustrate simulation results of the combined event C, event D and periodic strategies versus the event based reporting method disclosed in the present invention.

To quantify the performance of the different reporting methods two quality factors are defined: Total Number of Reports in a Day and Total Number of NonReported Alarms in a Day. The first one is a way to measure the reporting rate required by the different reporting strategies, while the second one informs about the number of times that the corresponding reporting method would have to have reported but it did not do it. In the simulation, it was counted the total number of times that the load, after a report and before the next one, rose/fell an amount greater/lower than the specific trigger threshold respect to the last reported value. For example, for the event based reporting method, if the ‘MinTBR’ control parameter is set to zero, there will never be non-reported alarms, while for the standard's combination (‘Event C+Event D+Periodic’) there are two sources for non-reported alarms:
i) A slow and cumulative change in the load not detected by the algorithm.
ii) A fast change that, although it was detected, it could not be reported because it just occurred during the next Tc or Td seconds after a report.

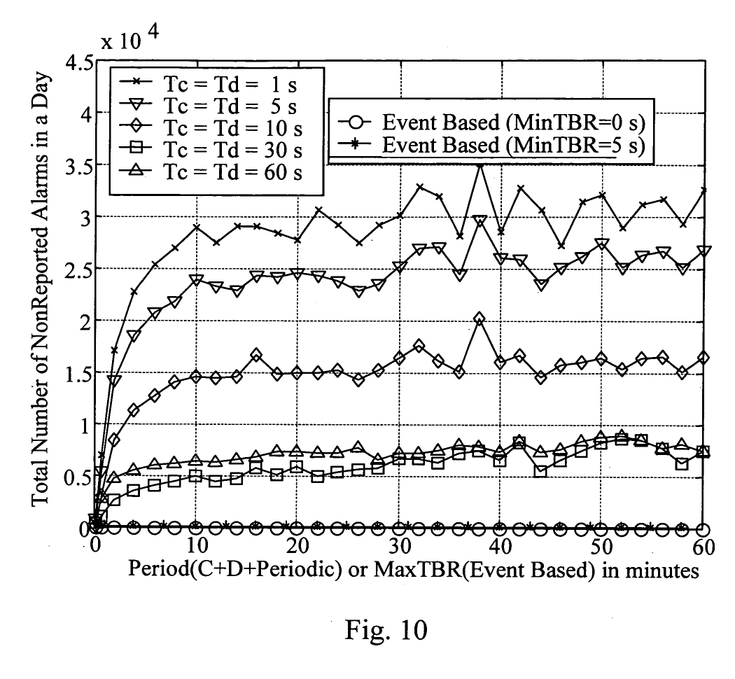

The previously defined quality factors obtained for the event based reporting method and for the combined strategy, ‘Event C+Event D+Periodic’ representative, are shown in the FIGS. 9 and 10. Simulations were made by varying ‘Period’ (for the ‘Event C+Event D+Periodic’ strategy) or ‘MaxTBR’ (for the event based reporting method), depending on the case for different values of ‘Tc’, ‘Td’ and ‘MinTBR’. In both figures the trigger threshold was fixed to 10%.

The explanation of the observed performance for the ‘Event C+Event D+Periodic’ strategy is the following. For a fixed and low value of ‘Tc’ and ‘Td’, if the period or distance between periodic reports is increased (FIG. 9), the total number of reports during a day decreases. However, the price of a considerable increment in the number of NonReported Alarms is paid (FIG. 10), obviously caused by the undetected slow changes. In the limit, when the period is very large, the ‘Event C+Event D+Periodic’ strategy works like an ‘Event C+Event D’ one. As it was described earlier, to reduce the number of NonReported Alarms produced by the undetected slow changes, the parameters ‘Tc’ and ‘Td’ can be enlarged. This is just the observed effect in FIG. 10 but at an expense of a considerable growth in the Total Number of Reports in a Day, as it can be seen in FIG. 9.

It should be noticed that when ‘Tc’ and ‘Tc’ are very large (greater than 30 seconds) the aforementioned performance is inverted, that is, the number of reports diminishes again, and the number of NonReported Alarms grows again. Such change is easily understood because, although an increment of ‘Tc’ and ‘Td’ have a clear positive effect over the number of NonReported Alarms produced by the slow changes, it has also a negative one over the fast changes that can take place just after a report, specifically during the next ‘Tc’ and ‘Td’ seconds.

On the other hand, the observed performance for the event based reporting method, disclosed in the present invention, is the following. The number of NonReported Alarms is drastically reduced to a very low value (0 and 4 alarms for ‘MinTBR’=0 at ‘MinTBR’=5 seconds), as illustrated in FIG. 10. This differs essentially from the 5000 alarms that were obtained in the best case of ‘Event C+Event D+Periodic’ strategy, again as illustrated in FIG. 10. The reason of such an important reduction is that both the slow and fast changes can be controlled simultaneously. The first ones, introducing a report at ‘MaxTBR’, and then resetting the trigger condition hereafter, if the load during the time interval ‘MinTBR’<t<‘MaxTBR’ after the last report was always included between the upper and lower trigger thresholds. The second ones, the fast changes, are the only ones that may cause an increment in the number of NonReported Alarms, just when they take place during the interval 0<t<‘MinTBR’.

The price to pay for such excellent performance is an increment in the Total Number of Reports. Nevertheless, compared with the situation in which the ‘Event C+Event D+Periodic’ strategy reached a minimum in the number of NonReported Alarms (5000 Alarms for ‘Tc’=‘Td’=30 seconds, as illustrated in FIG. 10), the required reporting rate for the event based reporting method is even smaller (900 versus 1200 reports in a day, as illustrated in FIG. 9).

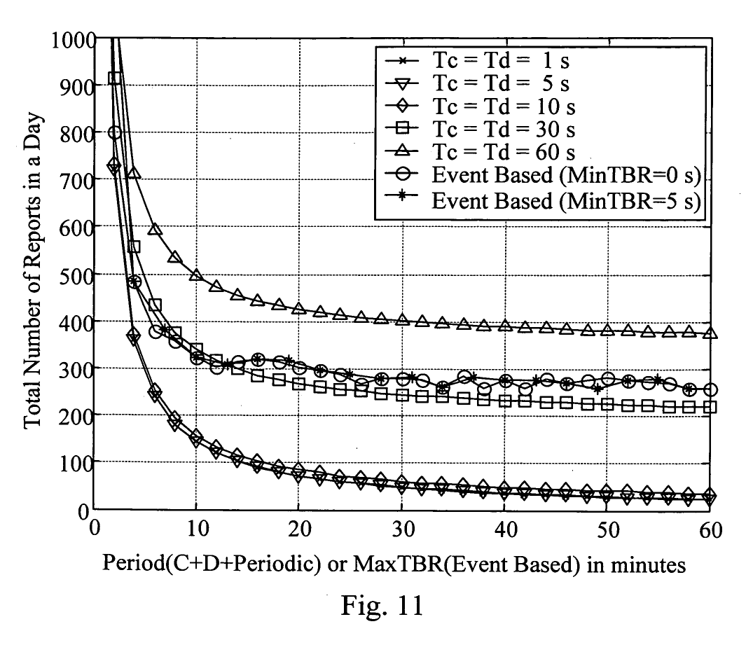

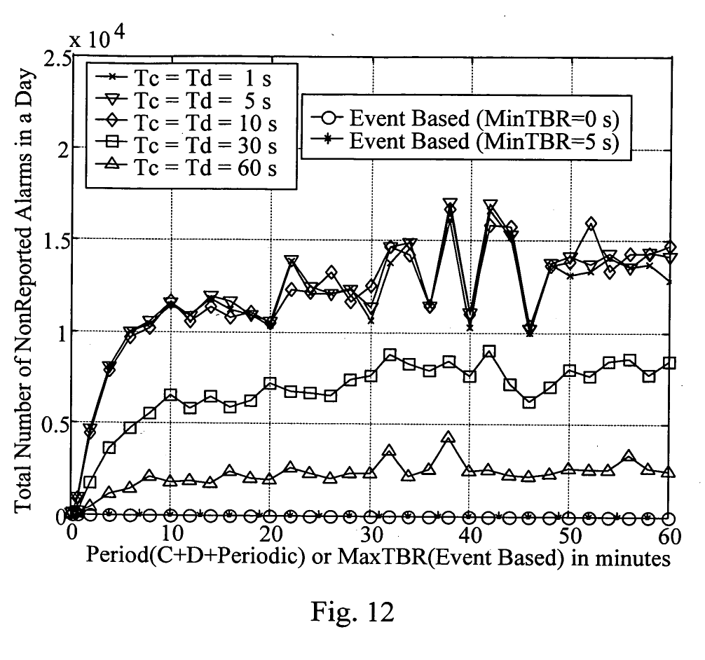

FIGS. 11 and 12 illustrate the effect of the threshold value. In FIGS. 11 and 12, ‘Threshold’ has the value of 20%. As it can be clearly seen, the threshold affects both the Total Number of Reports (FIG. 11) and the Total Number of NonReported Alarms (FIG. 12). A higher threshold will diminish the magnitude of both quality factors, while a lower threshold will have the opposite effect.

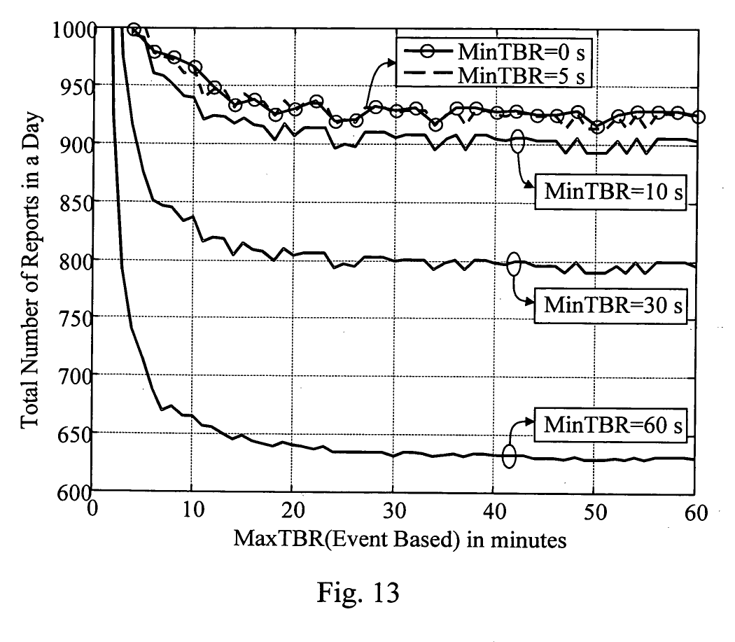

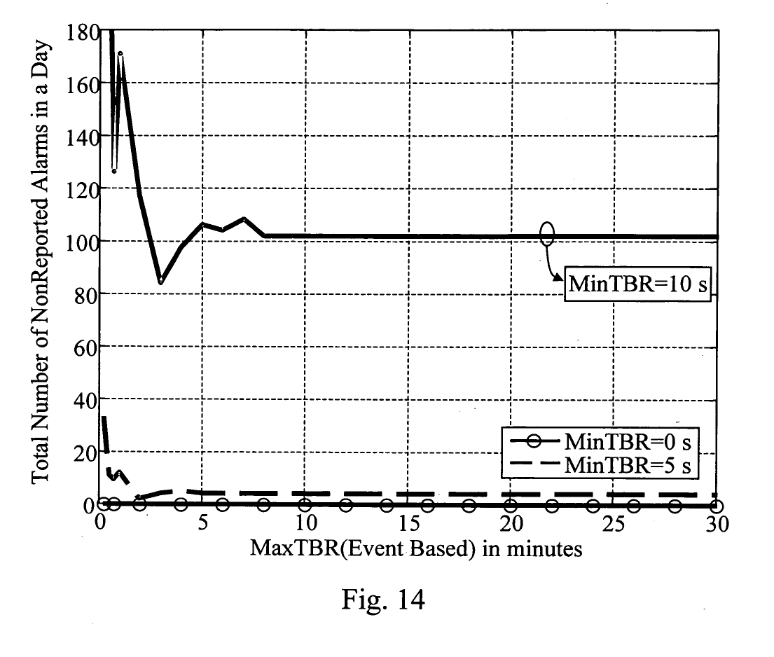

FIGS. 13 and 14 illustrate the effect of ‘MinTBR’ parameter value on the performance of the event based reporting method disclosed in the present invention. As it has already been established, the ‘MinTBR’ allows controlling the reporting rate between entities. Its effect on the quality factors is shown in FIGS. 13 and 14. As it can be clearly seen, higher values of ‘MinTBR’ reduces the Total Number of Reports (FIG. 13), although at expense of an increment in the Number of Non-Reported Alarms (FIG. 14). However, compared with the effect that higher values of ‘Tc’ and ‘Td’ produced over the ‘Event C+Event D+Periodic’ strategy (see FIG. 10), it is evident that now their consequences over the Total Number of NonReported Alarms are less dramatic.

The present invention describes a new and powerful strategy for reporting through the respective interfaces the needed parameters. Although the new strategy would imply to change the philosophy used so far by including a new format of reporting of event triggered type, it has been shown that its performance is superior to the reporting methods suggested by the ETSI standard TS 125 423 V4.1.0 (2001-06). The main property of the event based reporting method is its flexibility and adaptability because it is able to change the reporting rate depending on the status of the network. That is, it sends more reports or less reports depending on if the status (the load for example) of the network is changing quickly or slowly, respectively.

It is obvious to a person skilled in the art that with the advancement of technology, the basic idea of the invention may be implemented in various ways. The invention and its embodiments are thus not limited to the examples described above, instead they may vary within the scope of the claims.

1. A flexible reporting method for interchanging information between different entities of a data network, wherein said data network comprises one or more data network parameters to be reported between different entities, wherein the method comprises the step of:
reporting one or more data network parameter values between different entities of said data network according to a reporting scheme,
characterised in that in the method:
said reporting scheme of a data network parameter is based on the relative change of said data network parameter value with respect to the previously reported data network parameter value.

2. The method according to claim 1, characterised in that the method comprises at least one of the following steps:
determining a threshold value for each data network parameter to be reported, said threshold value representing allowable deviation in a data network parameter value to be reported with respect to the previously reported data network parameter value;
determining a minimum time interval representing the time interval after the previous data network parameter report within which no reports are allowed to be sent; and
determining a maximum time interval representing the time interval after the previous data network parameter report after which a report is sent if any report has not been sent within said maximum time interval.

3. The method according to claim 2, characterised in that the method comprises the steps of:
starting a timer after the previous data network parameter report; and if a data network parameter to be reported changes more than said threshold value, and said timer value is less than said minimum time interval,
rejecting the report.

4. The method according to claim 2, characterised in that the method comprises the steps of:
starting a timer after the previous data network parameter report, and if a data network parameter to be reported changes more than said threshold value, and the value of said timer exceeds said minimum time interval and the value of said timer is less than said maximum time interval,
reporting the current data network parameter value; and
restarting said timer.

5. The method according to claim 2, characterised in that the method comprises the steps of:
starting a timer after the previous data network parameter report; and if no report has been sent after the previous data network parameter report, and said timer reaches said maximum time interval,
reporting the current data network parameter value; and
restarting said timer.

6. The method according to claim 1, characterised in that the method comprises the step of:
filtering data network parameter values before reporting them.

7. The method according to claim 1, characterised in that said data network is a wireless communication network.

8. The method according to claim 7, characterised in that sending said reported wireless network parameter values with a radio resource controller of said wireless communication network.

9. The method according to claim 7, characterised in that receiving said reported wireless network parameter values with a radio resource management node of said wireless communication network.

10. A flexible reporting system for interchanging information between different entities of a data network, wherein said data network comprises one or more data network parameter values that are interchanged between different data network entities, wherein the system further comprises:
a data network entity (RRC) which reports data network parameter values;
a receiving network entity (RRM) which receives said reported data network parameter values sent by said data network entity (RRC);
characterised in that:
said data network entity (RRC) comprises a reporting scheme for one or more data network parameters, said reporting scheme being based on the relative change of a data network parameter value with respect to the previously reported data network parameter value.

11. The system according to claim 10, characterised in that the system comprises:
means for determining (DM) a threshold value (TH) for each data network parameter to be reported, said threshold value (TH) representing allowable deviation in a data network parameter value to be reported with respect to the previously reported data network parameter value;
means for determining (DM) a minimum time interval (MIN) representing the time interval after the previous data network parameter report within which no reports are allowed to be sent; and
means for determining (DM) a maximum time interval (MAX) representing the time interval after the previous data network parameter report after which a report is sent if any report has not been sent within said maximum time interval (MAX).

12. The system according to claim 11, characterised in that the system comprises:
a timer (T1 . . . Tn) for each data network parameter to be reported, said timer (T1 . . . Tn) being started after the previous data parameter report; and
means for rejecting (RM) the report if a data network parameter to be reported changes more than said threshold value (TH), and said timer (T1 . . . Tn) value is less than said minimum time interval (MIN).

13. The system according to claim 11, characterised in that the system comprises:
a timer (T1 . . . Tn) for each data network parameter to be reported, said timer (T1 . . . Tn) being started after the previous data network parameter report;
means for reporting (SM) the current data network parameter value when a data network parameter to be reported changes more than said threshold value (TH), and the value of said timer (T1 . . . Tn) exceeds said minimum time interval (MIN) and the value of said timer (T1 . . . Tn) is less than said maximum time interval (MAX); and
means for restarting (RE) said timer (T1 . . . Tn).

14. The system according to claim 11, characterised in that the system comprises:
a timer (T1 . . . Tn) for each data network parameter to be reported, said timer (T1 . . . Tn) being started after the previous data network parameter report;
means for reporting (SM) the current data network parameter value when no report has been sent after the previous data network parameter report and when said timer (T1 . . . Tn) reaches said maximum time interval (MAX); and
means for restarting (RE) said timer (T1 . . . Tn).

15. The system according to claim 10, characterised in that the system comprises:
means for filtering (FM) data network parameter values before making the reporting decision.

16. The system according to claim 10, characterised in that said data network is a wireless communication network.

17. The system according to claim 16, characterised in that said wireless communication network is the UTRAN.

18. The system according to claim 17, characterised in that the RNC of the UTRAN comprises said data network entity (RRC).

19. The system according to claim 16, characterised in that said wireless communication network is the IP-RAN.

20. The system according to claim 19, characterised in that the IP-BTS of the IP-RAN comprises said data network entity (RRC).

21. The system according to claim 16, characterised in that said wireless communication network is the GSM, GPRS or EDGE.

22. The system according to claim 21, characterised in that the BSC of the GSM, GPRS or EDGE comprises said data network entity (RRC).

23. A data network entity (RRC) for reporting information to other entities in a data network, wherein said data network entity (RRC) reports one or more data network parameter values to other data network entities within said data network, wherein said data network entity comprises:
a first interface (IF1) for receiving data network parameter information;
a second interface (IF2) for reporting one or more data network parameter values according to a reporting scheme;
characterised in that:
said reporting scheme is based on the relative change of a data network parameter value with respect to the previously reported data network parameter value.

24. The data network entity according to claim 23, characterised in that the data network entity (RRC) comprises:
means for determining (DM) a threshold value (TH) for each data network parameter to be reported, said threshold value (TH) representing allowable deviation in a data network parameter value to be reported with respect to the previously reported data network parameter value;
means for determining (DM) a minimum time interval (MIN) representing the time interval after the previous data network parameter report within which no reports are allowed to be sent; and
means for determining (DM) a maximum time interval (MAX) representing the time interval after the previous data network parameter report after which a report is sent if any report has not been sent within said maximum time interval (MAX).

25. The data network entity according to claim 24, characterised in that the data network entity (RRC) comprises:
a timer (T1 . . . Tn) for each data network parameter to be reported, said timer (T1 . . . Tn) being started after the previous data parameter report; and
means for rejecting (RM) the report if a data network parameter to be reported changes more than said threshold value (TH), and said timer (T1 . . . Tn) value is less than said minimum time interval (MIN).

26. The data network entity according to claim 24, characterised in that the data network entity (RRC) comprises:
a timer (T1 . . . Tn) for each data network parameter to be reported, said timer (T1 . . . Tn) being started after the previous data network parameter report;
means for reporting (SM) the current data network parameter value when a data network parameter to be reported changes more than said threshold value (TH), and the value of said timer (T1 . . . Tn) exceeds said minimum time interval (MIN) and the value of said timer (T1 . . . Tn) is less than said maximum time interval (MAX); and
means for restarting (RE) said timer (T1 . . . Tn).

27. The data network entity according to claim 24, characterised in that the data network entity (RRC) comprises:
a timer (T1 . . . Tn) for each data network parameter to be reported, said timer (T1 . . . Tn) being started after the previous data network parameter report;
means for reporting (SM) the current data network parameter value when no report has been sent after the previous data network parameter report and when said timer (T1 . . . Tn) reaches said maximum time interval (MAX); and
means for restarting (RE) said timer.

28. The data network entity according to claim 23, characterised in that the data network entity (RRC) comprises:
means for filtering (FM) data network parameter values received with said first interface (IF1) before reporting data network parameter values through said second interface (IF2).

29. The data network entity according to claim 23, characterised in that said data network is a wireless communication network.

30. The data network entity according to claim 29, characterised in that said wireless communication network is the UTRAN.

31. The data network entity according to claim 30, characterised in that the RNC of the UTRAN comprises said data network entity (RRC).

32. The data network entity according to claim 29, characterised in that said wireless communication network is the IP-RAN.

33. The data network entity according to claim 32, characterised in that the IP-BTS of the IP-RAN comprises said data network entity (RRC).

34. The data network entity according to claim 29, characterised in that said wireless communication network is the GSM, GPRS or EDGE.

35. The data network entity according to claim 34, characterised in that the BSC of the GSM, GPRS or EDGE comprises said data network entity (RRC).
